(19) United States
(12) Patent Application Publication
(10) Pub. No.: US 2010/0028665 A1
(43) Pub. Date: Feb. 4, 2010

(54) LOW-CREEP ZIRCON MATERIAL WITH NANO-ADDITIVES AND METHOD OF MAKING SAME

(76) Inventor: Yanxia Lu, Painted Post, NY (US)

Correspondence Address: CORNING INCORPORATED, SP-TI-3-1, CORNING, NY, 14831, US

(21) Appl. No.: 12/256,588

(22) Filed: Oct. 23, 2008

Related U.S. Application Data
(60) Provisional application No. 61/000,484, filed on Oct. 26, 2007.
(60) Provisional application No. 61/190,376, filed on Aug. 28, 2008.

(51) Int. Cl. C04B 35/488; C04B 35/64; B32B 18/00; C04B 35/482

(52) U.S. Cl. 428/338; 264/681; 264/667

(57) ABSTRACT

A composite material consisting essentially of ZrSiO₄ and sintering additives selected from Type I, Type II and Type III sintering additives and combinations thereof in amounts indicated below:

| | | |
|---|---|---|
| Type I: | 0.0-0.1 wt % | selected from Fe₂O₃, SnO₂, oxide glasses, |
| | | and mixtures and combinations thereof |
| Type II: | 0.1-0.8 wt % | selected from TiO₂, SiO₂, VO₂, CoO, NiO, |
| | | NbO, and mixtures and combinations thereof |
| Type III: | 0.0-0.8 wt % | selected from Y₂O₃, ZrO₂, CaO, MgO, Cr₂O₃, |
| | | Al₂O₃, and mixtures and combinations thereof |

wherein the amount of sintering additives are weight percentages on an oxide basis of the total weight of the composition, as well as method for making such composite material. The present invention is particularly useful for making large-size refractory bodies resistant to creep at an elevated operating temperature, such as an isopipe for fusion draw glass making processes.

### CROSS-REFERENCE TO RELATED APPLICATIONS

This application claims the benefit of priority to U.S. Provisional Application Ser. No. 61/000,484 filed on Oct. 26, 2007 and entitled “Low-Creep Zircon Material with Nano-Additives and Method of Making Same,” and U.S. Provisional Application Ser. No. 61/190,376 filed on Aug. 28, 2008 and entitled “Low-Creep Zircon Material with Nano-Additives and Method of Making Same,” the contents of which are incorporated herein by reference in their entirety.

### TECHNICAL FIELD

The present invention relates to zircon material, articles comprising same and method for making same. In particular, the present invention relates to low-creep sintered zircon material comprising sintering additives, articles comprising same and method of making same. The present invention is useful, e.g., for making low-creep zircon-based isopipe for fusion draw glass manufacturing processes.

### BACKGROUND

Certain applications require the use of high-temperature-resistance material with low deformation over the service life thereof at a high service temperature. Zircon (ZrSiO₄) represents one of those candidate materials. However, the deformation resistance of a zircon material is dependent on the manufacture process and composition thereof. Certain zircon materials were found to have relatively high creep at a high working temperature over 1500° C.

For example, isopipe is a key component in the fusion process for making precision flat glass. Conventional zircon isopipe is made from zircon minerals (commercial zircon) with several sintering additives, such as titania, iron oxides, glass components, etc. It possesses good creep resistance. However, for large glass panel manufacturing, since the sag, which is related to the creep rate, is proportional to the size of isopipe, the service life of an isopipe will be much reduced as isopipe size increases.

Other materials were previously proposed to reduce creep and/or variation thereof However, the creep rate is still too high for large isopipe. This invention describes how to use sintering additives in zircon to maximize the densification of the material during sintering and minimize the creep rate during use.

### SUMMARY

According to a first aspect of the present invention, provided is a composite material consisting essentially of zircon (ZrSiO₄) and sintering additives selected from Type I, Type II and Type III sintering additives and combinations thereof in amounts indicated below:

| | | |
|---|---|---|
| Type I: | 0.0-0.1 wt % | selected from Fe₂O₃, SnO₂, oxide glasses, |
| | | and mixtures and combinations thereof |
| Type II: | 0.1-0.8 wt % | seleced from TiO₂, SiO₂, VO₂, CoO, NiO, |
| | | NbO, and mixtures and combinations thereof |
| Type III: | 0.0-0.8 wt % | selected from Y₂O₃, ZrO₂, CaO, MgO, Cr₂O₃, |
| | | Al₂O₃, and mixtures and combinations thereof |

wherein the amount of sintering additives are weight percentages on an oxide basis of the total weight of the composition.

According to certain embodiments of the first aspect of the present invention, the composite material has a porosity of less than 15% by volume, in certain embodiments less than 10%, in certain other embodiments less than 8%.

According to certain embodiments of the first aspect of the present invention, the composite material has a creep rate of less than 0.5×10⁻⁶ hour⁻¹, in certain embodiments of less than 0.3×10⁻⁶ hour⁻¹, in certain other embodiments less than 0.2×10⁻⁶ hour⁻¹.

According to certain embodiments of the first aspect of the present invention, the composite material comprises TiO₂ as a sintering additive.

According to certain embodiments of the first aspect of the present invention, the composite material comprises Y₂O₃ in the range of 0.0-0.8 wt % as a sintering additive.

According to certain embodiments of the first aspect of the present invention, the composite material comprises Y₂O₃ as the sole Type III sintering additive.

According to certain embodiments of the first aspect of the present invention, the composite material comprises TiO₂ as the sole Type II sintering additive, and Y₂O₃ as the sole Type III sintering additive.

According to certain embodiments of the first aspect of the present invention, the composite material comprises ZrSiO₄ grains bonded by the sintering additives, wherein the ZrSiO₄ grains have an average grain size of at least 1 μm, in certain embodiments at least 3 μm, in certain embodiments at least 5 μm, in certain embodiments at least 7 μm, in certain embodiments at least 8 μm. In certain embodiments, the ZrSiO₄ grains have an average grain size of not higher than 10 μm. In certain embodiments, the ZrSiO₄ grains have an average grain size of not higher than 15 μm.

According to certain embodiments of the first aspect of the present invention, the composite material is essentially free of a Type I sintering additive.

According to certain embodiments of the first aspect of the present invention, the composite material comprises a Type I sintering additive having a melting temperature of not higher than 1500° C.

According to certain embodiments of the first aspect of the present invention, the composite material comprises a Type I sintering additive having a melting temperature of at least 100° C. lower than the melting temperature of zircon.

According to certain embodiments of the first aspect of the present invention, the composite material comprises a Type III sintering additive having a melting temperature of higher than 1800° C.

According to certain embodiments of the first aspect of the present invention, the composite material comprises a Type III sintering additive having a melting temperature higher than zircon.

According to certain embodiments of the first aspect of the present invention, the composite material comprises at least one Type II sintering additive.

According to certain embodiments of the first aspect of the present invention, the composite material comprises a combination of Type II and Type III sintering additives.

According to a second aspect of the present invention, provided is a process for making a zircon composite article, comprising the following steps:

(i) providing a zircon powder having an average particle size of at least 1 μm, in certain embodiments at least 3 μm, in certain embodiments at least 5 μm, in certain embodiments at least 7 μm; in certain embodiments at least 8 μm;

(ii) providing a sintering additive or a precursor of a sintering additive selected from Type I, Type II and Type III in amounts indicated below, and combinations thereof:

| | | |
|---|---|---|
| Type I: | 0.0-0.1 wt % | selected from Fe₂O₃, SnO₂, oxide glasses, |
| | | and mixtures and combinations thereof |
| Type II: | 0.1-0.8 wt % | selected from TiO₂, SiO₂, VO₂, CoO, NiO, |
| | | NbO, and mixtures and combinations thereof |
| Type III: | 0.0~0.8 wt % | selected from Y₂O₃, ZrO₂, CaO, MgO, |
| | | Cr₂O₃, Al₂O₃, and mixtures and |
| | | combinations thereof |

(iii) mixing the zircon powder and the sintering additive or precursor thereof to obtain a mixture having substantially uniform distribution of the sintering additive therein;

(iv) pressing the mixture to obtain a preform; and

(v) sintering the preform at an elevated temperature to obtain a sintered article.

According to certain embodiments of the second aspect of the present invention, in step (ii), the sintering additive or precursor thereof is provided in the form of a liquid solution, a liquid dispersion, or mixture thereof.

According to certain embodiments of the second aspect of the present invention, in step (iv), pressing comprises isopressing.

According to certain embodiments of the second aspect of the present invention, in step (i), the average particle size of the zircon particles are not more than 15 μm.

According to certain embodiments of the second aspect of the present invention, in step (v), the elevated temperature is from about 1400° C. to 1800° C., in certain embodiments from 1500° C. to 1600° C.

According to a third aspect of the present invention, provided is a refractory body capable of operating at an elevated temperature above about 1000° C., in certain embodiments above about 1100° C., in certain other embodiments above about 1200° C., in certain other embodiments above about 1300° C., in certain other embodiments above about 1400° C., in certain other embodiments above about 1500° C., consisting of the composite material according to the first aspect of the present invention described summarily above and in detail below. In certain embodiments of the third aspect of the present invention, the refractory body is an isopipe for forming glass sheet in a fusion draw process.

One or more embodiments of the present invention has one or more of the following advantages. By including a Type II and a Type III sintering additive, the resultant composite material exhibits a low creep rate at a high temperature, good strength, and low shrinkage during firing. Therefore, such material is particularly useful for making large refractory bodies operating at an elevated temperature, e.g., an isopipe for use in the fusion draw technology for making high-precision glass sheets.

Additional features and advantages of the invention will be set forth in the detailed description which follows, and in part will be readily apparent to those skilled in the art from the description or recognized by practicing the invention as described in the written description and claims hereof as well as the appended drawings.

It is to be understood that the foregoing general description and the following detailed description are merely exemplary of the invention, and are intended to provide an overview or framework to understanding the nature and character of the invention as it is claimed.

The accompanying drawings are included to provide a further understanding of the invention, and are incorporated in and constitute a part of this specification.

### BRIEF DESCRIPTION OF THE DRAWINGS

In the accompanying drawings:

FIG. 1 is a diagram showing the zircon particle size distribution of the zircon powered used in the preparation of the composite materials according to certain embodiments of the present invention.

FIG. 2A is a SEM image of a composite material according to one embodiment of the present invention comprising TiO₂ as a sintering additive but without comprising Fe₂O₃ as a sintering additive.

FIG. 2B is a SEM image of another composite material according to another embodiment of the present invention comprising both TiO₂ and Fe₂O₃ as a sintering additive.

FIG. 3A is a SEM image of a composite material according to one embodiment of the present invention comprising TiO₂ as a sintering additive but without comprising Y₂O₃ as a sintering additive.

FIG. 33 is a SEM image of another composite material according to one embodiment of the present invention comprising both TiO₂ and Y₂O₃ as sintering additives.

### DETAILED DESCRIPTION

Unless otherwise indicated, all numbers such as those expressing weight percents of ingredients, dimensions, and values for certain physical properties used in the specification and claims are to be understood as being modified in all instances by the term “about.” It should also be understood that the precise numerical values used in the specification and claims form additional embodiments of the invention. Efforts have been made to ensure the accuracy of the numerical values disclosed in the Examples. Any measured numerical value, however, can inherently contain certain errors resulting from the standard deviation found in its respective measuring technique.

As used herein, in describing and claiming the present invention, the use of the indefinite article “a” or “an” means “at least one,” and should not be limited to “only one” unless explicitly indicated to the contrary. Thus, for example, reference to “a sintering additive” includes embodiments having two or more sintering additives, unless the context clearly indicates otherwise.

As used herein, a “wt %” or “weight percent” or “percent by weight” of a component, unless specifically stated to the contrary, is based on the total weight of the composition or article in which the component is included. As used herein, all percentages are by weight unless indicated otherwise.

The invention describes function of sintering additives in a zircon-based sintered composite material and discloses the compositions that contain optimized sintering additives, which lowers the creep rate by 3-5 times.

Sintering additives in a zircon-based sintering composite material can have two major functions: 1) to enable the densification during sintering; 2) to provide for creep resistance at elevated temperatures after sintering. Components conducive to the first function may or may not contribute to the second function. Accordingly, the present inventor categorizes the sintering additives into the following three types (Type I, Type II, and Type III) in the following TABLE I:

TABLE I
Categorization of sintering additives

| Sintering | Effect on | Effect on creep | Mechanism of effect | |
|---|---|---|---|---|
| additive Type | Densification | resistance | on creep resistance | Material |
| Type I | + | 0 or − | increases grain- | Glass; oxides with low |
| | | | boundary sliding | melting temperature |
| Type II | + | + | lower diffusional | Oxides with medium |
| | | | creeps or increase | melting temperature |
| | | | grain-boundary | |
| | | | strength or grain- | |
| | | | boundary pinning | |
| Type III | 0 or − | + | Increases grain- | Oxides with high |
| | | | boundary strength or | melting temperature |
| | | | grain-boundary | |
| | | | pinning | |

Each type of sintering additive has its own impact on the final sintered material. If used, Type I sintering additives can contribute to the densification of ceramic particles during sintering, resulting in a sintered material with relatively higher density. Zircon can not sinter itself very well, therefore sintering additives may be needed. However, since Type I sintering additives may not help creep resistance or even reduce the creep resistance of the sintered body, the amount used should be kept low—as long as the amount included is sufficient for the densification purpose. Type II sintering additive can contribute both to the creep resistance and densification. It can be used as a sole sintering additive for zircon if it provides desired density, sufficient strength and low creep at a desired level. Type III sintering additive is usually used in combination with Type I or Type II sintering additives since it typically does not make positive contribution to the densification. Combination of a plurality of sintering additives in multiple types can result in optimized combination of densification, strength and creep resistance.

Thus, one aspect of the present invention is a composite material consisting essentially of zircon and the following sintering additives, expressed in terms of weight percentages on an oxide basis of the total weight of the composition, as listed in the following TABLE II:

TABLE II

| Type of | | |
|---|---|---|
| sintering | | |
| additive | Amount | Candidates of Sintering Additive |
| Type I: | 0.0-0.1 wt % | selected from Fe₂O₃, SnO₂, glass, |
| | | and mixtures and combinations thereof |
| Type II: | 0.1-0.8 wt % | selected from TiO₂, SiO₂, VO₂, CoO, |
| | | NiO, NbO, etc, and mixtures and |
| | | combinations thereof |
| Type III: | 0.0-0.8 wt % | selected from Y₂O₃, ZrO₂, CaO, MgO, |
| | | Cr₂O₃, Al₂O₃, etc., and mixtures and |
| | | combinations thereof |

Since the material, when used in isopipes and/or other refractory bodies for handling molten glass material, typically would have direct contact with the molten glass, it is desired that the sintering additives included should be compatible with the molten glass.

The sintering additives are then mixed with zircon powder particles to obtain an intimate mixture thereof before sintering. All sintering additives are preferably nano particles, made either from liquid form by dissolving oxide precursor in a solvent, or nano powder, when contacting and mixed with the zircon powders. The nano-size sintering additives provide the most effective results on both sintering and grain-boundary pinning. A preferred process involves dissolving or dispersing nano-particles in liquid, followed by coating the mixture on zircon particles by wet mixing. The coated zircon particles are spray dried to form dispersed dry powder. A small quantity of organic binder may or may not be added into the dry zircon powder to enhance the green strength. In certain embodiments, the binder addition is at the end of ball milling of zircon with sintering additives, prior to spray drying. In certain embodiments, the binder is water soluble, such as methocellulose from DOW Chemical company, Midland Michigan, USA, or Duramax B1000 or B1022 from Japan. In certain embodiments, the binder content is in a range of 0.1-0.5 wt % against total inorganic weight. In certain embodiments, methocellulose is used as a binder and pre-dissolve in water prior to mixing with other components. The binder Duramax is a suspension with about 50% binder load. In one embodiment, the green body is formed by iso-press at 18000 psi for 0.5-5 min.

Certain advantages of certain embodiments of the present invention include, inter alia: (i) the use of lower quantity of sintering additive in zircon, total sintering additive is less than 1%; (ii) the use of high temperature refractory oxides to pin the grain boundaries makes the final material stronger at both room and high temperature, and makes grain-boundaries immoveable at high temperature and low stress; (iii) negative impact of sintering additive in the zircon composition is minimized; and (iv) nano-additives provide the maximum impact at low concentration.

### Examples

The invented compositions were made using E-milled zircon powder.

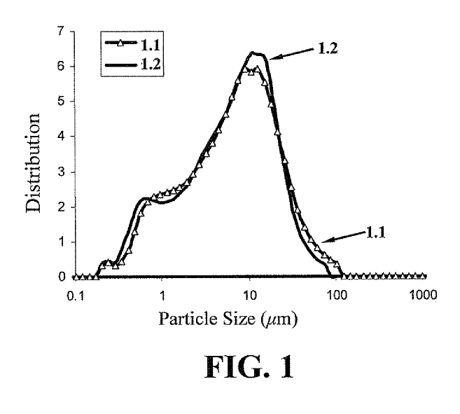

The E-milled zircon powder was a commercial product available with D50 in a range of 3-10 μm. FIG. 1 shows the particle size distribution of E-milled 7 μm zircon powder, the D50 (or 50%) of which is between 6 and 7 μm with broad particle size distribution. Further particle size distribution information of the zircon powders used in 1.1 and 1.2 are provided in TABLE III below.

TABLE III
Particle size distribution of zircon power used

| | | | | Surface area |
|---|---|---|---|---|
| Sample No. | 10% (μm) | 50% (μm) | 90% (μm) | (m² · g⁻¹) |
| 1.1 | 0.832 | 6.62 | 24.97 | 2.19 |
| 1.2 | 0.714 | 6.35 | 20.96 | 2.10 |

Such zircon powder has relatively large average grain size (higher than 1 μm), and provides lower grain-boundary concentration, which will reduce the grain boundary creep (Coble creep) in zircon. The Coble creep is believed to be a dominant creep mechanism in the creep of bulk zircon-based sintered composite materials. The large particle size and broad size distribution also made powder packing density (or tap density) high, which will minimize the total shrinkage from pressing to firing. However, the large particles are difficult to sinter by themselves without the aid of a sintering additive, so a sintering additive is necessary.

The sintering additive Type I is dedicated to binding the zircon powder particles. Oxides with low melting point have been usually used for such purpose. The oxides can be selected from Fe₂O₃, SnO₂, glass, etc., and precursors thereof. TABLE IV shows results of using iron oxide and TiO₂ as sintering additives. Precursors of Fe₂O₃ were pre-dissolved in water, and then mixed with titania sol. Such colloidal dispersion was then mixed with and coated on zircon powder by ball milling and spray drying. After spray drying, the powder was pressed by iso-presser at 18000 psi for 0.5-1 min. The thus formed greenbody was then sintered at 1580° C. for 48 hours to obtain the final material, which were then tested for strength, porosity, creep rate, and the like. The results did show that iron oxide is an excellent sintering additive, the porosity is reduced from 13.3% to 4.5% or below, the strength is higher at ambient condition. However, the creep rate is higher also at high temperature. With iron oxide as a sintering additive, the creep rate is almost doubled comparing to the one without it. Therefore, Fe₂O₃ is a typical Type I sintering additive.

For zircon-based composite material according to the present invention, Type II sintering additive has dual functions: densification and creep resistance improvement. Type II sintering additives can be selected from oxides (or its precursor), such as TiO₂, SiO₂, VO₂, CoO, NiO, NbO, etc. A series of sample materials containing TiO₂ as the sole sintering additive were prepared. The amounts of TiO₂ in the samples are listed in TABLE V. The process for making the sample materials was similar to the samples shown in TABLE IV. Nano additive (either colloidal or clear solution) is pre-mixed with zircon in liquid and then spray drying. The forming condition is at 18000 psi for 0.5-1 min. The results of using TiO₂ as the single sintering additive are shown in TABLE V.

Titania has shown some benefit for densification to zircon, but not as strong as iron oxides. However, it dramatically lowers the creep rate as shown in TABLE V. Without titiania sintering additive, the creep rate is over 1.0×10⁻⁶/h. The titiania sintering additive lowers the creep rate below 1.0×10⁻⁶/h even at very low concentration, such as 0.2 wt %. The result indicates that titania is a Type II sintering additive for zircon-based sintered composite materials.

Type III sintering additives are high temperature refractory. During the formation of the composite material, it is believed to have essentially no contribution to densification. Preferably it has no negative impact of densification. The oxides can be selected from Y₂O₃, ZrO₂, Y₂O₃ stabilized ZrO₂, CaO, MgO, Cr₂O₃, Al₂O₃, or their precursors. A series of sample materials containing both Y₂O₃ and TiO₂ as the sintering additives were prepared. The amounts of Y₂O₃ and TiO₂ in the samples are listed in TABLE VI. The yttria used was a fine powder (D100<10 μm), and titania precursors were titanium isopropoixde and titania colloidal sol. The process for making the sample materials was similar to the samples shown in TABLE IV. Test results of the materials are also shown in TABLE VI.

With yttria sintering additive, the creep rate was further reduced from 0.4-0.6×10⁻⁶/h range to the 0.1-0.3×10⁻⁶/h range regardless what titania precursors were used. The reduction of creep is not due to the reduction of porosity or densification, because the porosity is higher for some yttria-containing samples. The lower creep values with yttria indicate that high temperature refractory oxides, such as yttria, improve the creep resistance by strengthening the grain-boundary at high temperature by pinning the grain boundaries. Although the yttrium oxide is not a good sintering additive, but its strengthening to the grain-boundaries plays a role to maintain the low creep at high temperature and low stress. It proves that yttria is a good example of Type III sintering additive for the zircon-based sintered composite material according to the present invention.

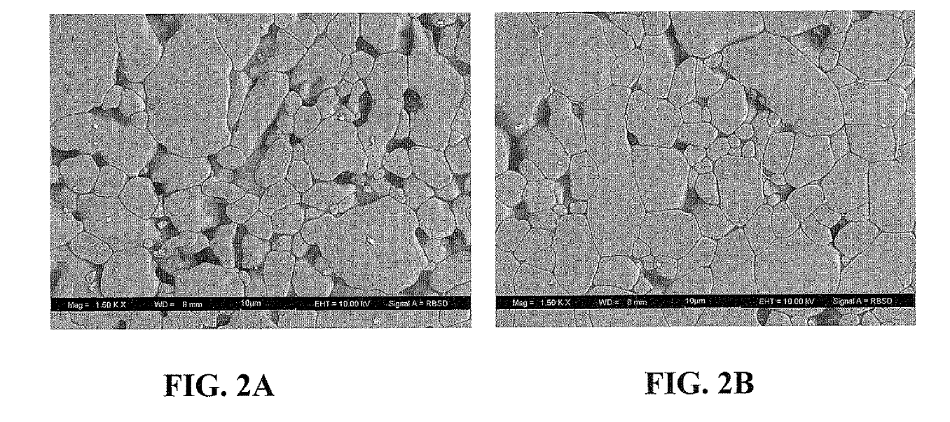

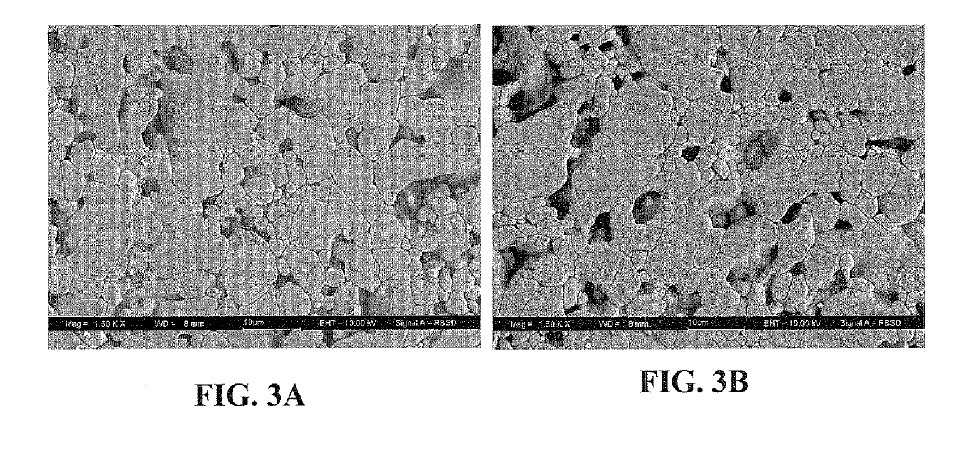

FIGS. 2A, 2B, 3A and 3B show the microstructure of zircon-based sintered composite materials with Type I, Type II and Type III sintering additives. They are the examples of how sintering additives impact density (or porosity). With iron oxide, the grain packing was higher comparing with the one without iron oxides. With Yttrium oxide, the grain packing had no change (FIG. 3B), the porosity was kept around 13%. However, it impacted the strength and creep dramatically; creep rate was reduced to 0.25×10⁻⁶/h from 0.85×10⁻⁶/h, while the strength increases more than 20%.

Overall, the three types of sintering additive contribute to zircon-based sintered composite materials in different ways. Optimizations of these nano-additives can lower the creep rate, and make composite materials that operate at its lowest creep rate and prolong the service life for glass molten manufacture.

It will be apparent to those skilled in the art that various modifications and alterations can be made to the present invention without departing from the scope and spirit of the invention. Thus, it is intended that the present invention cover the modifications and variations of this invention provided they come within the scope of the appended claims and their equivalents.

TABLE IV
Impact of iron oxide on sintering and creep

| | TiO₂ | Fe₂O₃ | | | | | |
|---|---|---|---|---|---|---|---|
| Example | sintering | sintering | Creep Rate | G-Density | G-porosity | Strength @ | |
| No. | additive | additive | (×10⁻⁶ · hr⁻¹) | (g · cm⁻³) | (%) | RT (psi) | Comment |
| 1 | 0.4% | 0% | 0.42 | 3.987 | 13.3 | 18151 | titania sintering additive only |
| 2 | 0.4% | 0.11% | 0.85 | 4.405 | 4.2 | 24430 | Citrate hydrated iron |
| 3 | 0.4% | 0.22% | 0.81 | 4.395 | 4.5 | 19136 | Fe₂O₃ Fumarate |
| 4 | 0.4% | 0.19% | 1.31 | 4.472 | 2.8 | 20294 | Fe₂O₃ oxalate |
| 5 | 0.4% | 0.20% | 0.76 | 4.443 | 3.4 | 21477 | Fe₂O₃ Gluconate |

| | | | | | |
|---|---|---|---|---|---|
| Comment | Titania sol | Different | Fe₂O₃ sintering | Fe₂O₃ improves | Fe₂O₃ |
| | precursor | iron oxide | additives increase | sintering a lot; lower | enhances |
| | | precursors | creep rate | porosity | strength |

TABLE V
Impact of titania on sintering and creep

| | | Creep Rate | G-Density | G-porosity | Strength @ RT | |
|---|---|---|---|---|---|---|
| Example No. | TiO_{2 (%)} | (×10⁻⁶ · hr⁻¹) | (g · cm⁻³) | (%) | (psi) | Sintering Additive Source |
| 6 | 0.0 | 1.260 | 3.924 | 14.7 | 17953 | No sintering additive |
| 7 | 0.2 | 0.527 | 4.052 | 11.9 | 16314 | Ti-isopropoxide |
| 8 | 0.2 | 0.706 | 3.936 | 14.4 | 18452 | Titania sol |
| 9 | 0.3 | 0.748 | 4.047 | 12.0 | 20389 | Titania sol |
| 10 | 0.4 | 0.422 | 3.987 | 13.3 | 18151 | Titania sol |
| 11 | 0.4 | 0.505 | 4.096 | 11.0 | 18703 | Ti-isopropoxide |
| 12 | 0.4 | 0.588 | 4.163 | 9.5 | 19029 | Tyzor |

| | | | |
|---|---|---|---|
| Comment | TiO₂ sintering | TiO₂ has some | TiO₂ has little impact |
| | additive lowers | impact on sintering | on strength |
| | creep rate | | |

TABLE VI
Impact of yttria on sintering and creep

| | | Y₂O₃ | | | | | |
|---|---|---|---|---|---|---|---|
| Example | TiO₂ sintering | sintering | Creep Rate | G-Density | G-porosity | Strength @ RT | |
| No. | additive (%) | additive (%) | (×10⁻⁶ · hr⁻¹) | (g · cm⁻³) | (%) | (psi) | Titania Precursor |
| 13 | 0.2 | 0 | 0.527 | 4.052 | 11.9 | 16314 | Ti-isopropoxide |
| 14 | 0.4 | 0 | 0.505 | 4.096 | 11.0 | 18703 | Ti-isopropoxide |
| 15 | 0.2 | 0.2 | 0.333 | 3.931 | 14.6 | 21359 | Ti-isopropoxide |
| 16 | 0.4 | 0.4 | 0.227 | 4.084 | 11.2 | 18745 | Ti-isopropoxide |
| 17 | 0.8 | 0.8 | 0.192 | 3.939 | 14.4 | 17064 | Ti-isopropoxide |
| 18 | 0.4 | 0 | 0.422 | 3.987 | 13.3 | 18151 | Titania sol |
| 19 | 0.2 | 0.2 | 0.253 | 3.988 | 13.3 | 21563 | Titania sol |
| 20 | 0.4 | 0.4 | 0.280 | 4.132 | 10.2 | 23199 | Titania sol |
| 21 | 0.8 | 0.8 | 0.308 | 4.123 | 10.4 | 19823 | Titania sol |
| 22 | 0.4 | 0.8 | 0.205 | 4.140 | 10.0 | 18418 | Titania sol |

| | | | | |
|---|---|---|---|---|
| Comment | Different titania | Yttria | Y₂O₃ sintering | Y₂O₃ has little |
| | precursor | powder | additive lowers | impact on sintering |
| | | | the creep rate | |

What is claimed is:

1. A composite material consisting essentially of zircon (ZrSiO₄) and a sintering additive selected from Type I, Type II and Type III sintering additives and combinations thereof in amounts indicated below:

| | | |
|---|---|---|
| Type I: | 0.0-0.1 wt % | selected from Fe₂O₃, SnO₂, oxide glasses, |
| | | and mixtures and combinations thereof |
| Type II: | 0.1-0.8 wt % | selected from TiO₂, SiO₂, VO₂, CoO, NiO, |
| | | NbO, and mixtures and combinations thereof |
| Type III: | 0.0-0.8 wt % | selected from Y₂O₃, ZrO₂, CaO, MgO, Cr₂O₃, |
| | | Al₂O₃, and mixtures and combinations thereof |

wherein the amount of sintering additives are weight percentages on an oxide basis of the total weight of the composition.

2. A composite material according to claim 1, having a total porosity of less than 15% by volume, in certain embodiments less than 10%, in certain other embodiments less than 8%.

3. A composite material according to claim 1, having a creep rate of less than 0.5×10⁻⁶ hour⁻¹.

4. A composite material according to claim 1, having a creep rate of less than 0.3×10⁻⁶ hour⁻¹.

5. A composite material according to claim 1, comprising TiO₂ as a sintering additive.

6. A composite material according to claim 1, comprising Y₂O₃ in the range of 0.0-0.8 wt %.

7. A composite material according to claim 1, comprising Y₂O₃ as the sole Type III sintering additive.

8. A composite material according to claim 1, comprising TiO₂ as the sole Type II sintering additive, and Y₂O₃ as the sole Type III sintering additive.

9. A composite material according to claim 1, comprising ZrSiO₄ grains bonded by the sintering additives, wherein the ZrSiO₄ grains have an average grain size of at least 1 μm, in certain embodiments at least 3 μm, in certain embodiments at least 5 μm, in certain embodiments at least 7 μm, in certain embodiments at least 10 μm.

10. A composite material according to claim 9, wherein the ZrSiO₄ grains have an average grain size of not higher than 15 μm.

11. A composite material according to claim 1, which is essentially free of a Type I sintering additive.

12. A composite material according to claim 1, wherein the Type I sintering additive has a melting temperature of not higher than 1500° C.

13. A composite material according to claim 1, wherein the Type I sintering additive has a melting temperature of at least 100° C. lower than the melting temperature of zircon.

14. A composite material according to claim 1, wherein the Type III sintering additive has a melting temperature of higher than 1800° C.

15. A composite material according to claim 1, wherein the Type III sintering additive has a melting temperature higher than zircon.

16. A composite material according to claim 1, comprising at least one Type II and at least one Type III sintering additive.

17. A process for making a zircon composite article, comprising the following steps:
(i) providing a zircon powder having an average particle size of at least 1 μm, in certain embodiments at least 3 μm, in certain embodiments at least 5 μm, in certain embodiments at least 7 μm; in certain embodiments at least 10 μm;
(ii) providing a sintering additive or a precursor of a sintering additive selected from those listed in the Table below in the amounts listed in the Table below, and combinations thereof:

| Type of | | |
|---|---|---|
| sintering | | |
| additive | Amount | Candidates of sintering additive |
| Type I: | 0.0-0.1 wt % | selected from Fe₂O₃, SnO₂, and mixtures and |
| | | combinations thereof |
| Type II: | 0.1-0.8 wt % | selected from TiO₂, SiO₂, VO₂, CoO, NiO, |
| | | NbO, and mixtures and combinations thereof |
| Type III: | 0.0-0.8 wt % | selected from Y₂O₃, ZrO₂, CaO, MgO, Cr₂O₃, |
| | | Al₂O₃, and mixtures and combinations thereof |

(iii) mixing the zircon powder and the sintering additive or precursor thereof to obtain a mixture having substantially uniform distribution of the sintering additive therein;
(iv) pressing the mixture to obtain a preform; and
(v) sintering the preform at an elevated temperature to obtain a sintered article.

18. A process according to claim 17, wherein in step (ii), the sintering additive or precursor thereof is provided in the form of a liquid solution, a liquid dispersion, or mixture thereof.

19. A process according to claim 17, wherein in step (iv), pressing comprises isopressing.

20. A process according to claim 17, wherein in step (i), the average particle size of the zircon particles are not more than 15 μm.

21. A process according to claim 17, wherein in step (v), the elevated temperature is from about 1400° C. to 1800° C.
